(19) United States
(12) Patent Application Publication
(10) Pub. No.: US 2015/0124201 A1
(43) Pub. Date: May 7, 2015

(54) POLARIZING PLATE AND LIQUID CRYSTAL DISPLAY HAVING THE SAME

(71) Applicant: Samsung Display Co., Ltd., Yongin-City (KR)

(72) Inventors: Boo-Kan KI, Yongin-si (KR); Kyeongha KIM, Hwaseong-si (KR); Min Oh CHOI, Cheonan-si (KR); Seungbeom PARK, Hwaseong-si (KR); YongHwan SHIN, Yongin-si (KR)

(73) Assignee: Samsung Display Co., Ltd., Yongin-City (KR)

(21) Appl. No.: 14/273,353

(22) Filed: May 8, 2014

(30) Foreign Application Priority Data
Nov. 1, 2013 (KR) 10-2013-0132312

(51) Int. Cl. G02F 1/13363; G02F 1/1335

(52) U.S. Cl. CPC G02F 1/133636; G02F 1/133528; G02F 2001/133531
USPC 349/96

(57) ABSTRACT

A liquid crystal display comprises a liquid crystal panel, a polarizing film provided on at least one surface of the liquid crystal film and having a polarizing axis, and a compensation film provided between the liquid crystal panel and the polarizing plate.

### CROSS-REFERENCE TO RELATED APPLICATIONS

This US non-provisional patent application claims priority under 35 USC §119 to Korean Patent Application No. 10-2013-0132312, filed on Nov. 1, 2013, the entirety of which is hereby incorporated by reference in its entirety.

### BACKGROUND

1. Field

This disclosure relates to a polarizing plate and a liquid crystal display having the same.

2. Description of the Related Art

A liquid crystal display includes a liquid crystal panel and a pair of polarizing plates at both sides of the liquid crystal display. Generally, the liquid crystal display includes an array substrate having a plurality of pixels arranged in a matrix, an opposite substrate facing the array substrate, and liquid crystal molecules disposed between the array substrate and the opposite substrate. The liquid crystal panel may have various liquid crystal modes according to an array structure and a liquid crystal phase of the liquid crystal molecules. For example, liquid crystal panels may be classified into nematic liquid crystal panels having nematic liquid crystal molecules and smectic liquid crystal panels having smectic liquid crystal molecules.

Twisted nematic liquid crystal displays are representative liquid crystal displays having a nematic liquid crystal phase. Twisted nematic liquid crystal displays have excellent light transmittance but narrow viewing angles as compared with other liquid crystal displays.

Discotic liquid crystal (DLC) compensation films may be used for twisted nematic liquid crystal displays to compensate for narrow viewing angles. Such DLC compensation films are manufactured by coating tri-acetyl-cellulose films with discotic liquid crystals. That is, DLC compensation films are manufactured through complex processes, and thus DLC compensation films are expensive.

### SUMMARY

Some embodiments provide liquid crystal displays. In some embodiments, a liquid crystal display may include a liquid crystal panel; two polarizing films provided on both surfaces of the liquid crystal panel; and two compensation films provided between the liquid crystal panel and each of the polarizing films. An angle (θp) formed by two polarizing axes of the polarizing films and an angle (θr) formed by two optical axes of the compensation films satisfy the Formula as follows:

−2°≦θr−θp≦2°

In some embodiments, the two polarizing films may include a first polarizing film provided on one surface of the liquid crystal panel and having a first polarizing axis and a second polarizing film provided on the other surface of the liquid crystal panel and having a second polarizing axis. The two compensation films include a first compensation film provided between the liquid crystal panel and the first polarizing film and having a first optical axis and a second compensation film provided between the liquid crystal panel and the second polarizing film and having a second optical axis.

In some embodiments, the angle (θr) formed by the first optical axis and the second optical axis may be between 88° and 92°.

In some embodiments, the first optical axis and the second optical axis may be disposed on facing two of four quadrants divided by the first polarizing axis and the second polarizing axis when a crossing of the first polarizing axis and the second polarizing axis matches a crossing of the first optical axis and the second optical axis. The first polarizing axis and the second polarizing axis may perpendicularly cross each other.

In some embodiments, the angle (θp) formed by the first polarizing axis and the second polarizing axis may be between 88° and 92°. The first optical axis and the second optical axis may be disposed on facing two of four quadrants divided by the first polarizing axis and the second polarizing axis when a crossing of the first polarizing axis and the second polarizing axis matches a crossing of the first optical axis and the second optical axis.

In some embodiments, the first optical axis and the second optical axis perpendicularly cross each other.

In some embodiments, in the respective first and second compensation films, if one surface of each of the first and second compensation films is defined as an x-y plane, the optical axis of the each compensation film is defined as a z′-axis, a surface perpendicular to the optical axis and passing an x-axis is defined as an x-y′ plane. A first retardation value (Ro′) of each of the compensation films is defined as (nₓ−n_{y}′)xd, and a second retardation value (Rₜₕ′) of each of the compensation films is defined as [(nₓ+n_{y}′)/2−n_{z}′]xd. The first retardation value Ro' and the second retardation value Rₜₕ′ satisfy the Formula (1) below:

0.92≦Rₜₕ′/Rₒ′≦4.75 Formula (1):

where n represents a refractive index of the respective axes and d represents a z-axis directional thickness of each of the compensation films.

In some embodiment, the first retardation value may be a retardation value for the x-y′ plane, and the second retardation value may be a retardation for the z′-axis of each of the compensation films.

In some embodiments, the first retardation value may be between 40 nm and 100 nm, and the second retardation value may be between 110 nm and 200 nm.

### BRIEF DESCRIPTION OF THE DRAWINGS

The above and other objects and features will become apparent from the following description with reference to the following figures, wherein like reference numerals refer to like parts throughout the various figures unless otherwise specified, and wherein:

FIG. 1 is a cross-sectional view of a liquid crystal display according to an exemplary embodiment;

FIG. 2 is a top plan view of the liquid crystal display in FIG. 1;

FIG. 3 is a cross-sectional view taken along the line I-I′ in FIG. 2;

FIG. 4 is an exploded perspective view of a liquid crystal display according to an exemplary embodiment;

FIG. 5 is a perspective view of a first compensation film in FIG. 4;

FIG. 6 illustrates an angle formed by two polarizing axes of polarizing films and an angle formed by two optical axes of compensation films in a liquid crystal display according to an exemplary embodiment;

FIGS. 7A and 7B are graphs showing contrast ratios depending on up/down/left/right viewing angles when (θr−θp) is 1° and 2° in a liquid crystal display employing a polarizing plate according to an exemplary embodiment, respectively;

FIG. 8 shows gamma curves representing optical characteristics with comparative examples 1 to 4 in a liquid crystal display employing a conventional DLC compensation film and liquid crystal displays employing different tilted optical axis compensation films;

FIG. 9A shows a gamma curve depending on a value of (θr−θp) when viewing a liquid crystal display at a position of left 60° on the basis of 0° that is a normal direction of a liquid crystal display;

FIG. 9B shows a gamma curve depending on a value of (θr−θp) when viewing a liquid crystal display at a position of right 60° on the basis of 0° that is a normal direction of a liquid crystal display; and

FIGS. 10A and 10B are graphs showing contrast ratios depending on up/down/left/right viewing angles when (θr−θp) is −1° and −2° in a liquid crystal display employing a polarizing plate according to an exemplary embodiment, respectively.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the embodiments to those skilled in the art. Accordingly, known processes, elements, and techniques may not be described with respect to some of the exemplary embodiments. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the exemplary embodiment.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it may be the only layer between the two layers, or one or more intervening layers may also be present.

The terminology used herein is for the purpose of describing particular embodiments only and is not intended to be limiting of the exemplary embodiment. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this technology belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

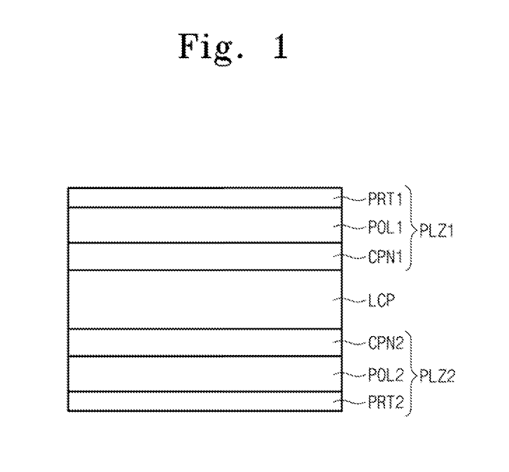

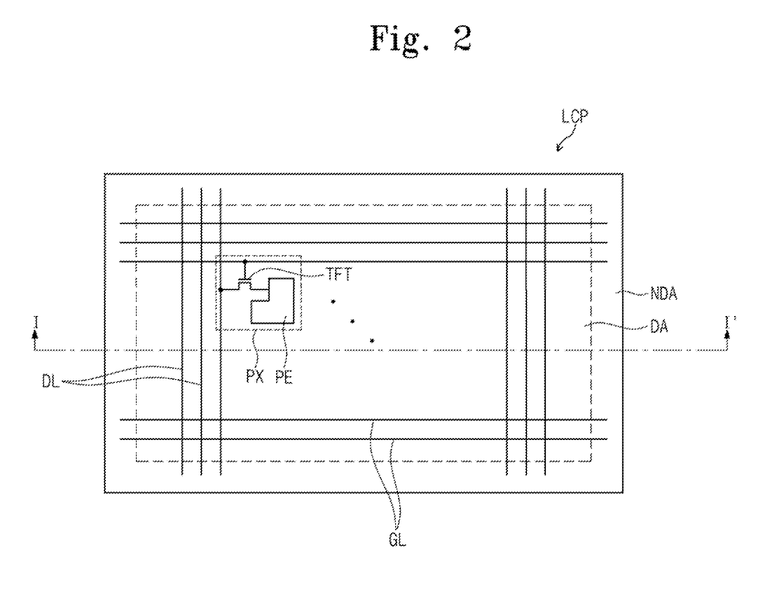

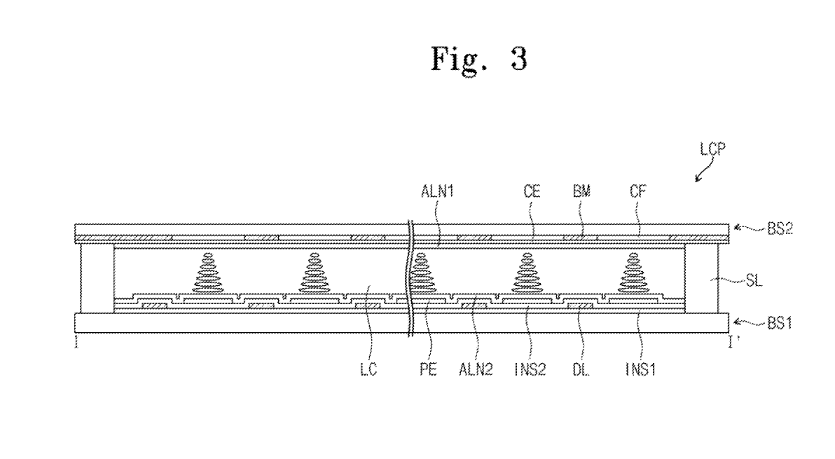

FIG. 1 is a cross-sectional view of a liquid crystal display according to an exemplary embodiment. FIG. 2 is a top plan view of the liquid crystal display in FIG. 1, and FIG. 3 is a cross-sectional view taken along the line I-I′ in FIG. 2.

Referring to FIGS. 1 to 3, the liquid crystal display includes a liquid crystal panel LCP and a polarizing plate provided on at least one surface of the liquid crystal panel LCP.

The liquid crystal panel LCP includes a first substrate BS1, a second substrate BS2 opposite to the first substrate BS1, a sealant SL, and a liquid crystal LC provided between the first substrate BS1 and the second substrate BS2. The liquid crystal LC includes a twisted nematic liquid crystal.

The first substrate BS1 includes a display area DA in which a plurality of pixels PX are provided to display an image and a non-display area NDA in which an image is not displayed. The non-display area NDA corresponds to at least one side of the display area DA.

The first substrate BS1 is provided with a wiring portion to transmit a signal and a pixel PX. The wiring portion includes a plurality of gate lines GL disposed on the first substrate BS1 and a plurality of data lines DL crossing the gate lines GL. The pixel PX includes thin film transistors (TFTs) connected to the gate lines GL and the data lines DL and a pixel electrode PE connected to the thin film transistors TFTs. Each of the thin film transistors TFTs is connected to a corresponding one of the gate lines GL and a corresponding one of the data lines DL and applies a pixel voltage to the pixel electrode PE.

Each of the thin film transistors TFTs includes a gate electrode, an active layer, a source electrode, and a drain electrode. The gate electrode branches from a corresponding one of the gate lines GL. A first insulating layer INS1 is disposed on the first substrate BS1 to cover the gate electrode. An active layer is disposed on the first insulating layer INS1, and the source electrode and the drain electrode are spaced apart from each other to expose the active layer. The data lines DL are disposed on the first insulating layer INS1. The source electrode branches from a corresponding one of the data lines DL.

A second insulating layer INK is provided on the first insulating layer INS1 to cover the source electrode, the drain electrode, and the exposed active layer. The pixel electrode PE is provided to the second insulating layer INS2 to be electrically connected to the drain electrode through a contact hole in each of the pixels PX.

A common electrode CE disposed on one surface opposite to the first substrate BS1 is provided on the second substrate BS2. A color filter CF and a black matrix BM may be provided together on the second substrate BS2. The black matrix BM has a plurality of opening regions facing the pixel electrode PE disposed on the first substrate BS1 and having the same shape as the pixel electrode PE. A plurality of color filters CF are provided on the opening regions of the black matrix BM. The respective color filters may display colors such as red, green, and blue.

A liquid crystal LC is provided between the first substrate BS1 and the second substrate BS2. The liquid crystal LC may include a twisted nematic liquid crystal. Dielectric anisotropy (Δε) of the twisted nematic liquid crystal may be between about 7 and about 13, and a retardation value (Δnd) of the twisted nematic liquid crystal may be between 400 nm and 480 nm. The dielectric anisotropy and the retardation value of the twisted nematic liquid crystal may vary depending on characteristics of a polarizing film and a compensation film that will be described later.

The sealant SL is disposed in the non-display area between the first substrate BS1 and the second substrate BS2. The sealant SL is provided along the circumference of the first substrate BS1 or the second substrate BS2 to seal the liquid crystal LC.

A first alignment layer ALN1 and a second alignment layer ALN2 are provided between the liquid crystal LC and the first substrate BS1 and between the liquid crystal LC and the second substrate BS2 to align the liquid crystal LC, respectively.

The polarizing plate may be provided on both opposite surfaces of the liquid crystal panel LCP, but may be provided on only one surface of the liquid crystal panel LCP. If the polarizing plate is provided on both surfaces of the liquid crystal panel LCP, the polarizing plate includes a first polarizing plate PLZ1 provided on one surface (e.g., top surface) of the liquid crystal panel LCP and a second polarizing plate PLZ2 provided on the other surface (e.g., bottom surface) of the liquid crystal panel LCP. If the polarizing plate is provided on only one surface of the liquid crystal panel LCP, another component having substantially the same function as the polarizing plate may be provided on the other surface of the liquid crystal panel LCP to correspond to the polarizing plate. In this embodiment, the polarizing plate including the first polarizing plate PLZ1 and the second polarizing plate PLZ2 will be exemplarily described.

The first polarizing plate PLZ1 includes a first compensation film CPN1 provided on the top surface of the liquid crystal panel LCP, a first polarizing film POL1 provided on the first compensation film CPN1, and a first protection film PRT1 provided on the first polarizing film POL1.

The second polarizing plate PLZ2 includes a second compensation film CPN2 provided on the bottom surface of the liquid crystal panel LCP, a second polarizing film POL2 provided on the second compensation film CPN2, and a second protection film PRT2 provided on the second polarizing film POL2. The first polarizing plate PLZ1 and the second polarizing plate PLZ2 will be described later in detail.

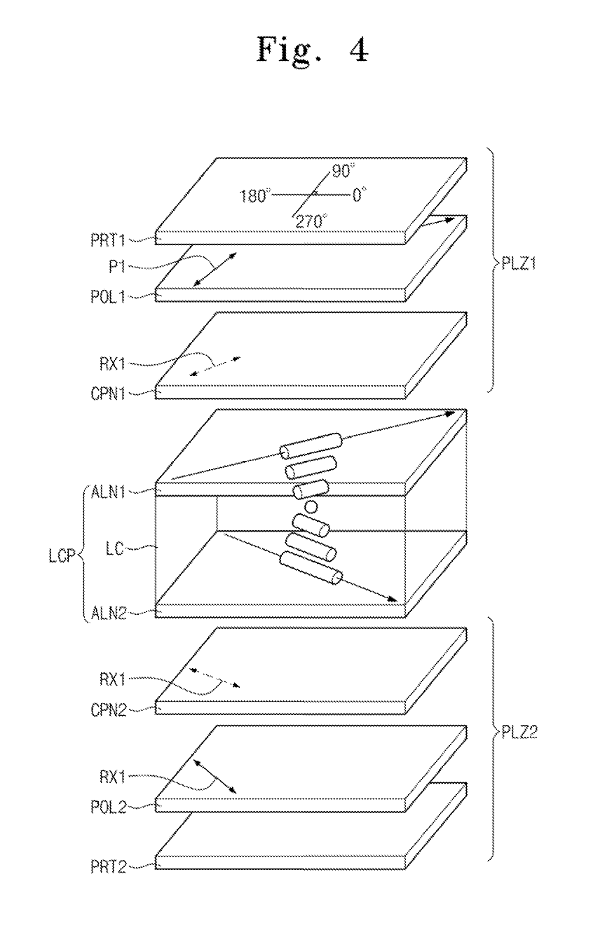

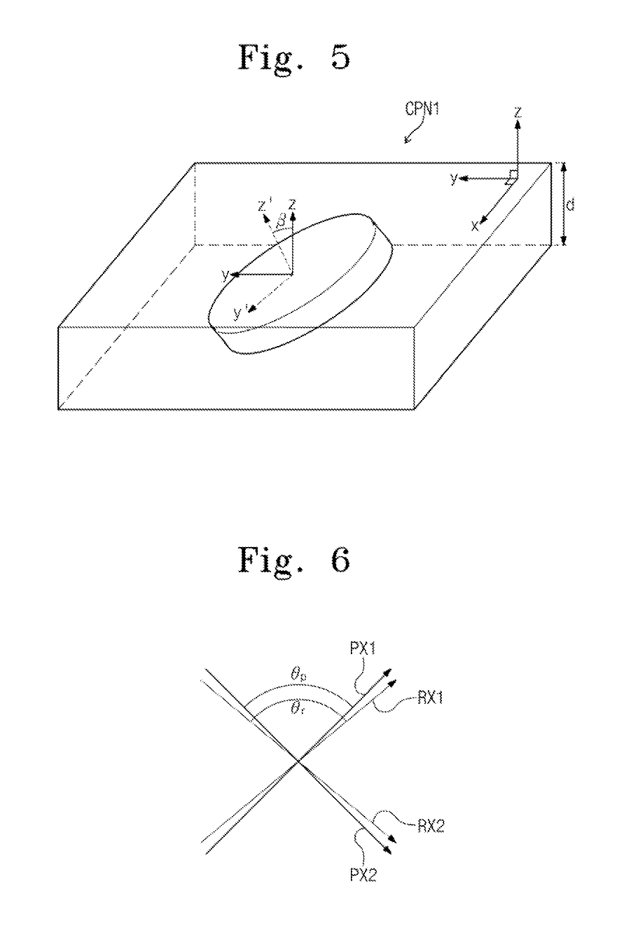

FIG. 4 is an exploded perspective view of a liquid crystal display according to an exemplary embodiment, and FIG. 5 is a perspective view only showing a first compensation film CPN1 in FIG. 4. FIG. 4 illustrates a relationship between components in the liquid crystal display according to an exemplary embodiment. For brevity of description, some components (e.g., a first substrate and a second substrate of a liquid crystal panel) are omitted in FIG. 4.

Referring to FIGS. 4 and 5, a first polarizing plate PLZ1 and a second polarizing plate PLZ2 are provided with a liquid crystal panel LCP interposed therebetween. The first polarizing plate PLZ1 includes a first compensation film CPN1, a first polarizing film POL1, and a first protection film PRT1 that are sequentially stacked on the liquid crystal panel LCP.

The liquid crystal panel LCP is provided in the form of rectangle having a pair of long sides and a pair of short sides. Hereinafter, an angle will be indicated based on one of extending directions of the long sides of the liquid crystal panel LCP. For example, one of the extending directions of the short side is 90° and its opposite direction is 270°.

The first polarizing film POL1 absorbs a light vibrating in a specific direction to polarize a light passing through the first polarizing film POL1 in a predetermined direction. In this embodiment, when the first polarizing film POL1 absorbs a light vibrating in a first direction, the first direction may be referred to as a first polarizing axis PX1. In an exemplary embodiment, the first polarizing axis PX1 has a direction of 45°±10°.

The first polarizing film POL1 is made of a polymeric resin stretched in a specific direction. The polymeric resin may be a polyvinyl alcohol resin. The polyvinyl alcohol resin is obtained by saponifying a polyvinyl acetate resin. The polyvinyl acetate resin is a homopolymer of vinyl acetate or a copolymer formed by copolymerizing the vinyl acetate with a monomer copolymerizable with the vinyl acetate. Examples of the monomer copolymerizable with the vinyl acetate are unsaturated carboxylic acid, olefin, vinyl ether, unsaturated sulfonic acid, and the like.

The first protection film PRT1 is provided on the first polarizing film POL1 to protect the first polarizing film POL1 from an external scratch or the like.

The first compensation film CPN1 compensates a viewing angle with respect to a light passing through the first polarizing plate PLZ1. The first compensation film CPN1 may be a monoaxially or biaxially stretched compensation film. In an exemplary embodiment, a biaxially stretched compensation film will be described as an example of the first compensation film CPN1. Hereinafter, in the first compensation film CPN1, one surface of the first compensation film CPN1 will be defined as an x-y plane, an upward direction of thickness directions will be defined as a z-axis, and refractive indices with respect to the directions will be represented by nx, ny, and nz. In addition, an optical axis of light passing through the first compensation film CPN1 will be referred to as a first optical axis RX1, which will be defined as a z′-axis. The first optical axis RX1 is directed toward the upward direction of the first compensation film CPN1, and a plane perpendicular to the z′-axis will be defined as an x-y′ plane. Refractive indices with respect to y′ and z′-axes are represented by ny′ and nz′, respectively. A first retardation value (Ro′) of the first compensation film CPN1 is defined as (nₓ−n_{y}′)xd, and a second retardation value (Rₜₕ′) of the first compensation films is defined as [(nₓ+n_{y}′)/2−nz′]xd. The first retardation value Ro′ and the second retardation value Rₜₕ′ satisfy the Formula (1) below:

0.92≦Rₜₕ′/Rₒ′≦4.75 Formula (1)

where d represents a z-axis directional thickness of the first compensation film CPN1.

In the first compensation film CPN1, refractive indices nx, ny′, and nz′ with respect to x, y′, and z′-axis directions have different values (i.e., nx≠ny′≠nz′). In some embodiments, the refractive indices nx, ny′, and nz′ with respect to x, y′, and z′-axis directions may satisfy the Formula nx>ny′≧nz′.

The first retardation value Ro′ is a retardation value with respect to the x-y′ plane, and the second retardation value Rₜₕ′ is a retardation value with respect to the z′-axis. Within the scope satisfying the above Formula 1, the first retardation value Ro′ may be between 40 nm and 100 nm and the second retardation value Rₜₕ′ may be between 110 nm and 200 nm. When the first retardation value Ro′ is less than 40 nm and the second retardation value Rₜₕ′ is less than 110 nm, it is difficult to prepare the first compensation film CPN1 and the retardation values are so small that the first compensation film CPN1 may not function as a compensation film. In addition, when the first retardation value Ro′ is greater than 100 nm and the second retardation value Rₜₕ′ is greater than 200 nm, it is difficult to match the first compensation film CPN1 with the liquid crystal panel LCP and the first polarizing film POL1 and the retardation values are so great that a desired transmittance and a desired viewing angle may not be obtained.

As described above, due to stretching during preparation of the first compensation film CPN1, z′-axis differing from z-axis serves as a first optical axis RX1 and the first optical axis RX1 is tilted toward the z-axis. On a cross section, an angle β between the first optical axis RX1 and the z-axis is between about 10° and about 25°. When viewed on the cross-section, the first optical axis RX1 is tilted toward a line parallel to the first polarizing axis PX1 by the above angle. That is, the x-y′ plane of the first compensation film CPN1 is tilted toward the line parallel to the first polarizing axis PX1 by the angle β.

The first compensation film CPN1 may be made of a thermoplastic resin. Examples of the thermoplastic resin include a polysulfone-based resin, a polymethyl methacrylate-based resin, a polystyrene-based resin, a polycarbonate-based resin, a polyvinyl chloride-based resin, and a norbornene-based resin. The thermoplastic resin may include a homopolymer, a copolymer, a block copolymer, an alternating block copolymer, a random polymer, a random copolymer, a random block copolymer, or the like, or a combination thereof. The thermoplastic resin may be solely used or mixed with another resin.

The above-structured first compensation film CPN1 may be prepared by a melt extrusion process. That is, the first compensation film CPN1 may be prepared by passing a thermoplastic resin between rollers of different rotation speeds after the thermoplastic resin is made proximate to a glass transition temperature of the thermoplastic resin (primary stretching) and passing the thermoplastic resin between rollers disposed in a different direction than the rollers (secondary stretching). Although the thermoplastic resin exhibits isotropy in a state proximate to the glass transition temperature, anisotropy is formed through the primary stretching and a tilt of an optical axis is adjusted through the secondary stretching. The primary stretching is carried out in a direction substantially parallel to the first polarizing axis, and the secondary stretching is carried out in a direction crossing the first polarizing axis. Angles of carrying out the primary stretching and the secondary stretching may vary depending on kind of the polymeric resin, strength of stretching, and an angle β between the first optical axis RX1 and the z-axis of the first compensation film CPN1 desired to be prepared when viewed on a cross section. In some embodiments, the primary stretching may be carried out in a direction of about 45°±10° and the secondary stretching may be carried out in a direction of about 315°±10°.

In the liquid crystal panel LCP, the first alignment layer ALN1 may be provided between the first substrate BS1 and the liquid crystal LC and may be rubbed in a direction substantially parallel to the first polarizing axis PX1, In some embodiments, the first alignment layer ALN1 is rubbed to have a direction of about 45°±10°.

The second polarizing film POL1, the second compensation film CPN2, and the second protection film PRT2 are disposed in the same manner as the first polarizing film POL1, the first compensation film CPN2, and the first protection film PRT2, respectively. In the second polarizing plate PLZ2, sections different from the first polarizing plate PLZ1 will be extensively described to avoid duplicate description and portions particularly unexplained follow the first polarizing plate PLZ1.

The second polarizing film POL2 has a second polarizing axis PX2 crossing the first polarizing axis PX1. In some embodiments, the second polarizing axis PX2 has a direction of about 135°±10°.

The second protection film PRT2 is provided on the second polarizing film POL2 to protect the second polarizing film POL2 from an external scratch or the like.

The second compensation film CPN2 compensates a viewing angle with respect to a light passing through the second polarizing plate PLZ2.

Hereinafter, in the second compensation film CPN2, one surface of the second compensation film CPN2 will be defined as an x-y plane, a downward direction of thickness directions will be defined as a z-axis, and refractive indices with respect to the directions will be represented by nx, ny, and nz. In addition, an optical axis of light passing through the second compensation film CPN2 will be referred to as a second optical axis RX2, which will be defined as a z′-axis. The second optical axis RX2 is directed toward a lower portion of the second compensation film CPN2, and a plane perpendicular to the z′-axis will be defined as an x-y′ plane. Refractive indices with respect to y′ and z′-axes are represented by ny′ and nz′, respectively.

Other than a z-axis and a direction of a second optical axis RX2, the second compensation film CPN2 has substantially the same configuration as the first compensation film CPN1. That is, when a surface perpendicular to the second optical axis RX2 and passing the x-axis is defined as an x-y′ plane, a first retardation value Ro′ of the second compensation film CPN2 is defined as (nₓ−n_{y}′)xd, and a second retardation value Rₜₕ′ of the second compensation film CPN2 is defined as [(nₓ+n_{y}′)/2−n_{z}′]xd, the first retardation value Ro′ and the second retardation value Rₜₕ′ satisfy the Formula (1), where d represents a z-axis directional thickness of the second compensation film CPN2.

In the second compensation film CPN2, the refractive indices nx, ny′, and nz′ with respect to the x, y′ and, z′-axis directions have different values (i.e., nx≠ny′≠nz′). In some embodiments, the refractive indices nx, ny′, and nz′ with respect to x, y′, and z′-axis directions may satisfy the Formula nx>ny′≧nz′.

The first retardation value Ro′ is a retardation value with respect to the x-y′ plane, and the second retardation value Rₜₕ′ is a retardation value with respect to the z′-axis. Within the scope satisfying the above Formula 1, the first retardation value Ro′ may be between 40 nm and 100 nm and the second retardation value Rₜₕ′ may be between 110 nm and 200 nm. When the first retardation value Ro′ is less than 40 nm and the second retardation value Rₜₕ′ is less than 110 nm, it is difficult to prepare the second compensation film CPN2 and the retardation values are so small that the second compensation film CPN2 may not function as a compensation film. In addition, when the first retardation value Ro′ is greater than 100 nm and the second retardation value Rₜₕ′ is greater than 200 nm, it is difficult to match the second compensation film CPN2 with the liquid crystal panel LCP and the second polarizing film POL2 and the retardation values are so great that a desired transmittance and a desired viewing angle may not be obtained.

As described above, due to stretching during preparation of the second compensation film CPN2, z′-axis differing from z-axis serves as a second optical axis RX2 and the second optical axis RX2 is tilted toward the z-axis. On a cross section, an angle β between the second optical axis RX2 and the z-axis is between about 10° and about 25°. When viewed on the cross-section, the second optical axis RX2 is tilted toward a line parallel to the second polarizing axis PX2 by the above angle. That is, the x-y′ plane of the second compensation film CPN2 is tilted toward the line parallel to the second polarizing axis PX2 by the angle β.

The above-structured second compensation film CPN2 may be prepared in the same method as the first compensation film CPN1. That is, the second compensation film CPN2 may be prepared by passing a thermoplastic resin between rollers of different rotation speeds after the thermoplastic resin is made proximate to a glass transition temperature of the thermoplastic resin (primary stretching) and passing the thermoplastic resin between rollers disposed in a different direction than the rollers (secondary stretching). The primary stretching is carried out in a direction substantially parallel to the second polarizing axis, and the secondary stretching is carried out in a direction crossing the second polarizing axis. Angles of carrying out the primary stretching and the secondary stretching may vary depending on kind of the polymeric resin, strength of stretching, and an angle β between the second optical axis RX2 and the z-axis of the second compensation film CPN2 desired to be prepared when viewed on a cross section. In some embodiments, the primary stretching may be carried out in a direction of about 135°±10° and the secondary stretching may be carried out in a direction of about 225°±10°.

In the liquid crystal panel LCP, the second alignment layer ALN2 may be provided between the first substrate BS1 and the liquid crystal LC and may be rubbed in a direction substantially parallel to the second polarizing axis PX2. In some embodiments, the second alignment layer ALN2 is rubbed to have a direction of about 315°±10°.

In some embodiments, an angle formed by two polarizing axes of the polarizing films and an angle formed by two optical axes of the compensation films have specific ranges.

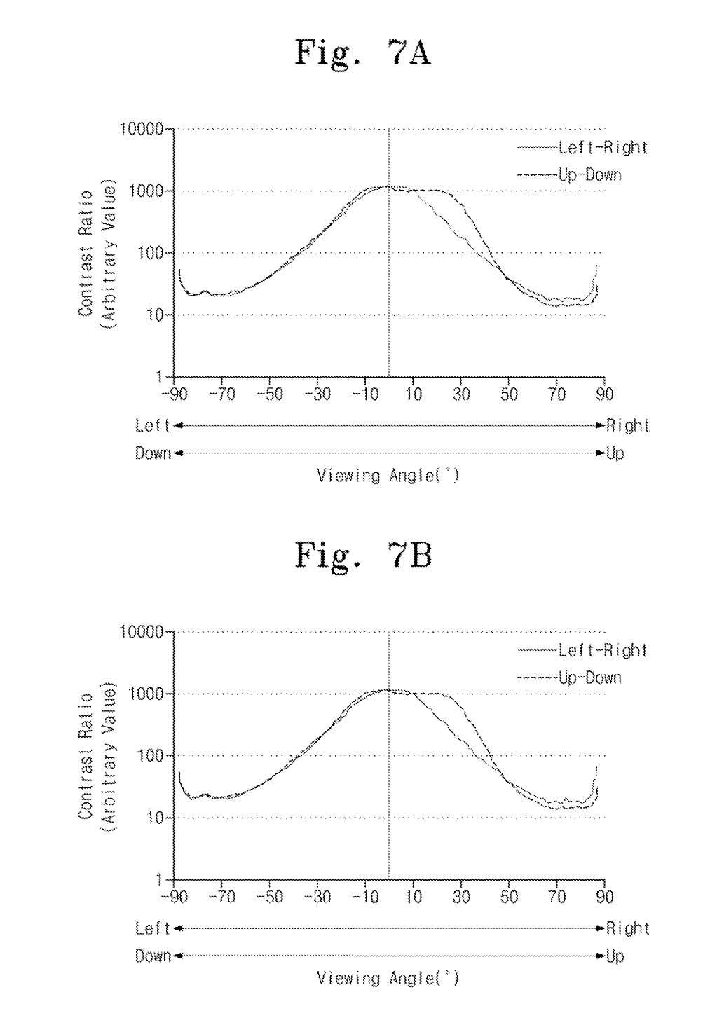

FIG. 6 illustrates an angle formed by two polarizing axes of polarizing films and an angle formed by two optical axes of compensation films in a liquid crystal display according to an exemplary embodiment. In FIG. 6, when viewed on a plane, only a first polarizing axis PX1 of a first polarizing plate, a second polarizing axis PX2 of a second polarizing plate, a first optical axis RX1 of a first compensation film, and a second optical axis RX2 of a second compensation film are shown after omitting the other components of the liquid crystal display.

Referring to FIG. 6, the first polarizing axis PX1 and the second polarizing axis PX2 cross each other, and the first optical axis RX1 and the second optical axis RX2 cross each other. An angle formed by the first optical axis RX1 and the second optical axis RX2 is a first angle θr, and an angle formed by the first polarizing axis PX1 and the second polarizing axis PX2 is a second angle θp. In FIG. 6, a crossing of the first optical axis RX1 and the second optical axis RX2 and a crossing of the first polarizing axis PX1 and the second polarizing axis PX2 match each other to compare the first angle θr with the second angle θp.

In some embodiments, the first angle θr and the second angle θp satisfy the Formula (2) below.

−2°<θr−θp<2° Formula (2)

In some embodiments, the first angle θr and the second angle θp may be about 88° and about 92° in the scope of satisfying the Formula 2, respectively.

In some embodiments, the first angle θr and the second angle θp may have different values. FIG. 6 shows a case where the first angle θr is greater than the second angle θp. When viewed on a plane, the first polarizing axis PX1 and the second polarizing axis PX2 divide the plane into four quadrants, and the first optical axis RX1 and the second optical axis RX2 are disposed in two quadrants facing each other. An angle formed by the first polarizing axis PX1 and the first optical axis RX1 may be equal to an angle formed by the second polarizing PX2 and the second optical axis RX2. In addition, an imaginary line passing through the crossing of the first polarizing axis PX1 and the second polarizing axis PX2 and making the first polarizing axis PX1 and the second polarizing axis PX2 axisymmetric may match an imaginary line passing through the crossing of the first optical axis RX1 and the second optical axis RX2 and making the first optical axis RX1 and the second optical axis RX2 axisymmetric.

In some embodiments, the first angle θr may be greater than the second angle θp. In this case, a viewing angle, particularly an upper viewing angle, of the liquid crystal display is widened. For example, in some embodiments, the first polarizing axis PX1 and the second polarizing axis PX2 may perpendicularly intersect and thus the second angle may be 90° and the first angle θr may be greater than about 88° and equal to or less than 92°. Alternatively, the first optical axis RX1 and the second optical axis RX2 may perpendicularly intersect and thus the first angle θr may be 90° and the second angle θp may be greater than 90° and less than 92°.

In some embodiments, although not shown in the figure, both the first angle θr and the second angle θp may be 90°. In this case, the first polarizing axis PX1 and the second optical axis RX1 match each other, and the second polarizing axis PX1 and the second optical axis RX2 match each other.

In the above-structured liquid crystal display, the polarizing films and the compensation films are employed to provide an image having a similar or wider viewing angle to or than a DLC compensation film and having a greater contrast ratio than the DLC compensation film. In addition, the polarizing films and the compensation films are employed to have a similar gamma curve to the DLC compensation film.

Table (1) shows optical characteristics in a liquid crystal display employing a conventional DLC compensation film and a liquid crystal display employing a typical titled optical axis compensation film through a comparative example 1 and a comparative example 2. In the Table (1), CR represents a contrast ratio in the front of a liquid crystal display and up/down/left/right angles represent angles from the surface of the liquid crystal display when the contrast ratio respectively indicates 10% of the contrast ratio to a front contrast ratio 100% with a user view moved in up/down/left/right directions. The front contrast ratio was measured on the basis of a normal direction of the liquid crystal display. To clarify, the up/down/left/right angles mean angles between the surface of the liquid crystal panel and the user's eyes, respectively. Other than polarizing plates, all conditions of the comparative example 1 and the comparative example 2 were identically maintained. In the comparative example 2, Ro and Rth of a tilted optical axis compensation film were 59 and 169, respectively.

TABLE (1)

| | CR | Angle (°) | | | |
|---|---|---|---|---|---|
| | (Relative Value) | Up | Down | Left | Right |
| Comparative | 550 | 18 | 14 | 23 | 31 |
| Example 1 | | | | | |
| Comparative | 1043 | 13.2 | 21.0 | 19.9 | 16.1 |
| Example 2 | | | | | |

As can be seen from the Table (1), an up viewing angle was significantly reduced more in the comparative example 2 using the titled optical axis compensation film than in the comparative example 1 using the conventional DLC compensation film. That is, the viewing angle decreased from 18° to 13.2°. In consideration of a frequency with respect to a direction of viewing a liquid crystal display that a user views, an up viewing angle needs to be wider than a down viewing angle. Thus, there is a need for expanding an up viewing angle when the titled optical axis compensation film is used.

The Table (2) shows a simulation result of optical characteristics according to a difference between a first angle and a second angle when an optical compensation film according to some embodiments is used. In the Table (2), “θr−θp” is a value measured while varying one of the first and second angles after the other angle is fixed to 90°.

TABLE 2

| | θr − θp | CR (Relative | Angle (°) | | | |
|---|---|---|---|---|---|---|
| | (°) | Value) | Up | Down | Left | Right |
| Embodiment 1 | 4 | 150 | 43.5 | 11.0 | 23.1 | 23.1 |
| Embodiment 2 | 3 | 212 | 39.7 | 11.9 | 25.2 | 25.2 |
| Embodiment 3 | 2 | 313 | 35.1 | 12.9 | 27.2 | 27.2 |
| Embodiment 4 | 1 | 474 | 30.5 | 14.1 | 28.8 | 28.9 |
| Embodiment 5 | 0 | 687 | 26.3 | 15.3 | 30.0 | 37.7 |
| Embodiment 6 | −1 | 804 | 22.6 | 16.6 | 30.6 | 30.7 |
| Embodiment 7 | −2 | 677 | 19.5 | 18.1 | 30.5 | 30.6 |
| Embodiment 8 | −3 | 464 | 16.9 | 19.6 | 29.8 | 29.9 |
| Embodiment 9 | −4 | 304 | 14.7 | 21.2 | 28.5 | 28.6 |

As can be seen from the Table (2), an up viewing angle extends as (θr−θp) increases. In particular, when the (θr−θp) are 1° and 2°, the up viewing angles are 30.5° and 35.1°, respectively. That is, the up viewing angle is much greater than that in a conventional art. However, when the (θr−θp) is 3° or greater, the up viewing angle increases but the down viewing angle exhibits a small value of 12° or less.

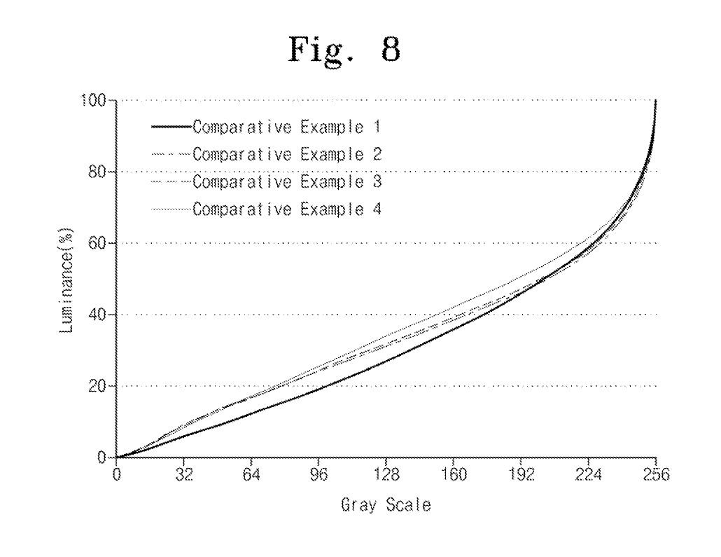

FIGS. 7A and 7B are graphs showing contrast ratios depending on viewing angles with the user view moved in up/down/left/right directions when (θr−θp) is 1° and 2° in a liquid crystal display employing a polarizing plate according to an exemplary embodiment, respectively. Polarizing axes and the optical axes were confirmed using an Axoscan System manufactured by Axometrics Inc., and contrast ratios were measured using an EZ Contrast manufactured by ELDIM.

Referring to FIG. 7A, when (θr−θp) was 1°, a contrast ratio in the front was 1280. The up/down/left/right angles when indicating 10% of contrast ratio to the front contrast ratio 100% exhibited 15.2°, 22.4°, 18.6°, and 17.1°, respectively.

Referring to FIG. 7B, when (θr−θp) was 2°, a contrast ratio in the front was 1246. The up/down/left/right angles when indicating 10% of contrast ratio to the front contrast ratio 100% exhibited 15.5°, 20.9°, 19.7°, and 18.8°, respectively.

As described in FIGS. 7A and 7B, in the liquid crystal display employing a polarizing plate according to some embodiments, a contrast ratio in the front exhibited the same level as in a liquid crystal display employing a conventional DLC compensation film. Similar to the same simulation, a viewing angle was also improved by 15° or greater in actually measured data as compared to a typical titled optical axis compensation film.

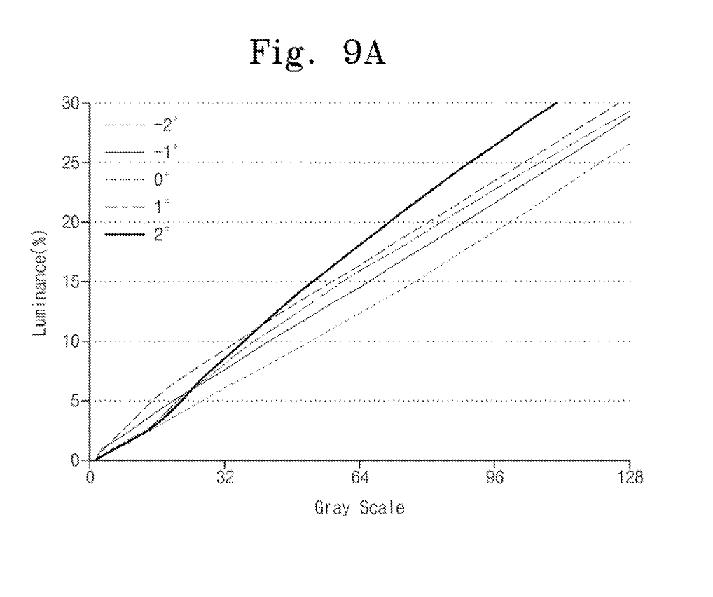

FIG. 8 shows gamma curves representing optical characteristics with the comparative examples 1 to 4 in a liquid crystal display employing a conventional DLC compensation film and liquid crystal displays employing different tilted optical axis compensation films. The liquid crystal display employing a conventional DLC compensation film corresponding to the comparative example 1, and liquid crystal displays employing typical titled optical axis compensation films correspond to the comparative examples 2 to 4, respectively.

Referring to FIG. 8, gamma curves of liquid crystal displays employing typical titled optical axis compensation films exhibit an upwardly shifted value as compared to a gamma curve of a conventional DLC compensation film. In the liquid crystal displays employing typical titled optical axis compensation films, an upwardly shifted phenomenon of the titled optical compensation films occurs particularly at low gray scale. For this reason, luminance needs to have a downwardly shifted value at low gray scale to obtain a gamma curve substantially corresponding to the conventional DLC compensation film even at the low gray scale.

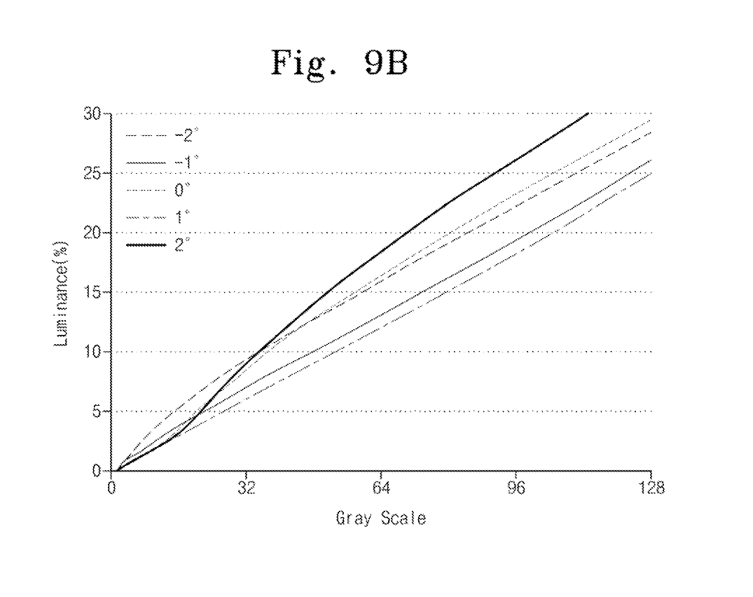

FIG. 9A shows a gamma curve depending on a value of (θr−θp) when viewing a liquid crystal display at a position of left 60° on the basis of 0° that is a normal direction of a liquid crystal display, and FIG. 9B shows a gamma curve depending on a value of (θr−θp) when viewing a liquid crystal display at a position of right 60° on the basis of 0° that is a normal direction of a liquid crystal display. In FIGS. 9A and 9B, each of the angles means (θr−θp). In addition, the gamma curves are shown only at the gray scale of 0 to 256 and at the gray scale of 0 to 128, respectively.

From FIGS. 9A and 9B, it can be seen that although there is a slight difference with the variation of gray scale, luminance is downwardly shifted as the value of (θr−θp) decreases, considering a general tendency. Particularly, a gamma curve exhibited a degree corresponding to a conventional DLC compensation film when the (θr−θp) is −1° and −2°. In this case, there is no meaningful difference of the gamma curve depending on left/right viewing angles.

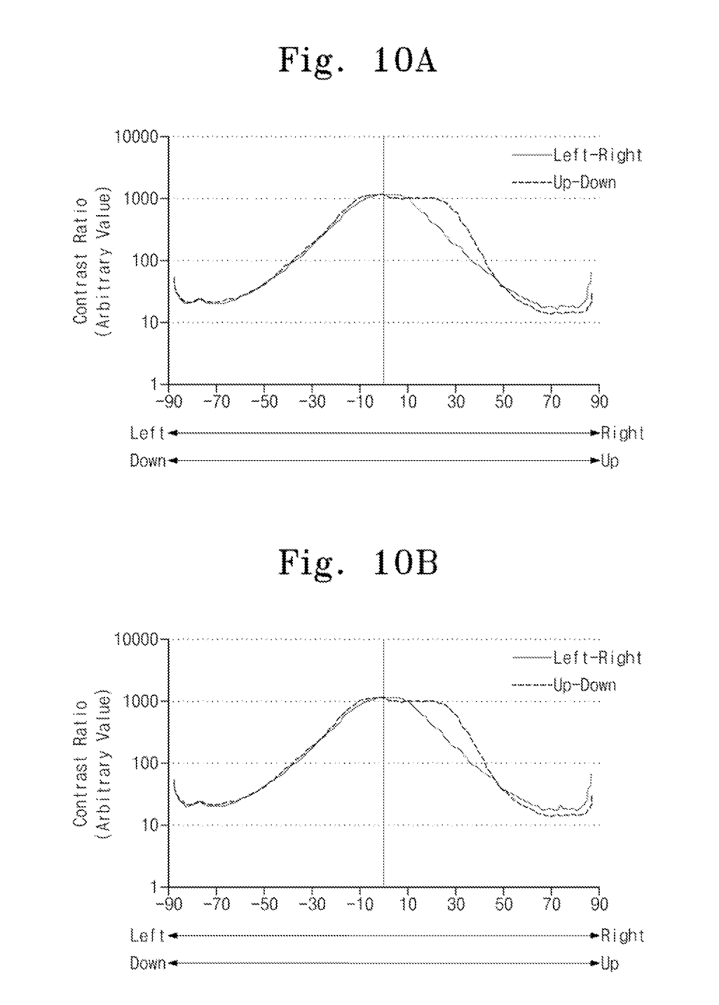

FIGS. 10A and 10B are graphs showing contrast ratios depending on viewing angles with the user view moved in up/down/left/right directions when (θr−θp) is −1° and −2° in a liquid crystal display employing a polarizing plate according to an exemplary embodiment, respectively.

Referring to FIG. 10A, a contrast ratio in the front was 1202 when the (θr−θp) was −1°. The up/down/left/right angles when indicating 10% of contrast ratio to the front contrast ratio 100% exhibited 14.1°, 22.5°, 21.9°, and 18.4°, on the basis of 0° that is a normal direction of the liquid crystal display, respectively.

Referring to FIG. 10B, a contrast ratio in the front was 1193 when the (θr−θp) was −2°. The up/down/left/right angles when indicating 10% of contrast ratio to the front contrast ratio 100% exhibited 14.1°, 22.2°, 21.2°, and 15.8° respectively.

As described in FIGS. 10A and 10B, in the liquid crystal display employing a polarizing plate according to some embodiments, a contrast ratio in the front exhibited the same level as that in a liquid crystal display employing a conventional DLC compensation film. Similar to the same simulation, a viewing angle was also improved by 14° or greater in actually measured data as compared to a typical titled optical axis compensation film.

As described above, in a liquid crystal display according to some embodiments, a difference between a first angle and a second angle is within a predetermined range to achieve a high contrast ratio, widen a top viewing angle, and have a gamma curve substantially corresponding to a conventional DLC.

As described so far, embodiments provide a polarizing plate having superior viewing angle characteristics and a superior contrast ratio and a liquid crystal display employing the polarizing plate. The liquid crystal display employs compensation films, instead of a DLC compensation film, to reduce manufacturing cost.

While the embodiments have been described with reference to exemplary embodiments, it will be apparent to those skilled in the art that various changes and modifications may be made without departing from the spirit and scope of the present embodiments. Therefore, it should be understood that the above exemplary embodiments are not limiting, but illustrative.

What is claimed is:

1. A liquid crystal display comprising:
a liquid crystal panel;
two polarizing films provided on both surfaces of the liquid crystal panel; and
two compensation films provided between the liquid crystal panel and each of the polarizing films,
wherein an angle (θp) formed by two polarizing axes of the polarizing films and an angle (θr) formed by two optical axes of the compensation films satisfy the Formula as follows:
−2°≦θr−θp≦2°.

2. The liquid crystal display as set forth in claim 1, wherein
the two polarizing films comprise a first polarizing film provided on one surface of the liquid crystal panel and having a first polarizing axis and a second polarizing film provided on the other surface of the liquid crystal panel and having a second polarizing axis; and
the two compensation films comprise a first compensation film provided between the liquid crystal panel and the first polarizing film and having a first optical axis and a second compensation film provided between the liquid crystal panel and the second polarizing film and having a second optical axis.

3. The liquid crystal display as set forth in claim 2, wherein the angle (θr) formed by the first optical axis and the second optical axis is between 88° and 92°.

4. The liquid crystal display as set forth in claim 2, wherein the first optical axis and the second optical axis are disposed on facing two of four quadrants divided by the first polarizing axis and the second polarizing axis when a crossing of the first polarizing axis and the second polarizing axis matches a crossing of the first optical axis and the second optical axis.

5. The liquid crystal display as set forth in claim 4, wherein the first polarizing axis and the second polarizing axis perpendicularly intersect each other.

6. The liquid crystal display as set forth in claim 2, wherein the angle (θp) formed by the first polarizing axis and the second polarizing axis are between 88° and 92°.

7. The liquid crystal display as set forth in claim 6, wherein the first optical axis and the second optical axis are disposed on facing two of four quadrants divided by the first polarizing axis and the second polarizing axis when a crossing of the first polarizing axis and the second polarizing axis matches a crossing of the first optical axis and the second optical axis.

8. The liquid crystal display as set forth in claim 7, wherein the first optical axis and the second optical axis perpendicularly intersect each other.

9. The liquid crystal display as set forth in claim 2, wherein
in the respective first and second compensation films, if one surface of each of the first and second compensation films is defined as an x-y plane, the optical axis of the each compensation film is defined as a z′-axis, a surface perpendicular to the optical axis and passing an x-axis is defined as an x-y′ plane, a first retardation value (Ro′) of each of the compensation films is defined as (nₓ−n_{y}′)xd, and a second retardation value (Rₜₕ′) of each of the compensation films is defined as [(nₓ+n_{y}′)/2−n_{z}′]xd, the first retardation value and the second retardation value satisfy the Formula as follows:
0.92≦Rₜₕ′/Rₒ′≦4.75
where n represents a refractive index of the respective axes and d represents a z-axis directional thickness of each of the compensation films.

10. The liquid crystal display as set forth in claim 9, wherein the first retardation value is a retardation value for the x-y′ plane, and the second retardation value is a retardation for the z′-axis of each of the compensation films.

11. The liquid crystal display as set forth in claim 10, wherein the first retardation value is between 40 nm and 100 nm, and the second retardation value is between 110 nm and 200 nm.

12. The liquid crystal display as set forth in claim 2, wherein in the respective first and second compensation films, an angle (β) between the optical axis and the z-axis of each of the compensation films is between 10° and 25°.

13. The liquid crystal display as set forth in claim 12, wherein the x-y′ plane of the first compensation film is titled to a line parallel to the first polarizing axis by the angle (β), and the x-y′ plane of the second compensation film is titled to a line parallel to the second polarizing axis by the angle (β).

14. The liquid crystal display as set forth in claim 1, wherein the liquid crystal panel comprises:
a first substrate;
a second substrate opposite to the first substrate; and
a liquid crystal provided between the first substrate and the second substrate, the liquid crystal being a twisted nematic liquid crystal.

15. The liquid crystal display as set forth in claim 14, wherein:
dielectric anisotropy of the twisted nematic liquid crystal is between 7 and 13.

16. The liquid crystal display as set forth in claim 14, wherein a retardation value of the twisted nematic liquid crystal is between 400 nm and 480 nm.

17. The liquid crystal display as set forth in claim 14, further comprising
a first alignment layer provided between the first substrate and the liquid crystal and aligned in the same direction as the first polarizing axis; and
a second alignment layer provided between the second substrate and the liquid crystal and aligned in the same direction as the second polarizing axis.

18. The liquid crystal display as set forth in claim 1, wherein each of the compensation films is made of a thermoplastic resin.

19. The liquid crystal display as set forth in claim 9, wherein each of the compensation films satisfies the Formula as follows:
nx>ny′≧nz′.
